(19) United States
(12) Patent Application Publication
(10) Pub. No.: US 2019/0377642 A1
(43) Pub. Date: Dec. 12, 2019

(54) DECOUPLED BACKUP SOLUTION FOR DISTRIBUTED DATABASES ACROSS A FAILOVER CLUSTER

(71) Applicant: EMC IP Holding Company LLC, Hopkinton, MA (US)

(72) Inventors: Asif Khan, Bangalore (IN); Matthew Dickey Buchman, Seattle, WA (US); Tushar B. Dethe, Bangalore (IN); Deepthi Urs, Bangalore (IN); Sunil Yadav, Bangalore (IN); Mahesh Reddy AV, Bangalore (IN); Swaroop Shankar D H, Bangalore (IN); Shelesh Chopra, Bangalore (IN)

(21) Appl. No.: 16/003,966

(22) Filed: Jun. 8, 2018

(51) Int. Cl. G06F 11/14; G06F 17/30

(52) U.S. Cl. CPC G06F 11/1464; G06F 2201/80; G06F 11/1451; G06F 17/30283

(57) ABSTRACT

A decoupled backup solution for distributed databases across a failover cluster. Specifically, a method and system disclosed herein improve upon a limitation of existing backup mechanisms involving distributed databases across a failover cluster. The limitation entails restraining backup agents, responsible for executing database backup processes across the failover cluster, from immediately initiating these aforementioned processes upon receipt of instructions. Rather, due to this limitation, these backup agents must wait until all backup agents, across the failover cluster, receive their respective instructions before being permitted to initiate the creation of backup copies of their relative distributed database. Subsequently, the limitation imposes an initiation delay on the backup processes, which the disclosed method and system omit, thereby granting any particular backup agent the capability to immediately (i.e., without delay) initiate those backup processes.

### BACKGROUND

Enterprise environments are gradually scaling up to include distributed database systems that consolidate ever-increasing amounts of data. Designing backup solutions for such large-scale environments are becoming more and more challenging as a variety of factors need to be considered. One such factor is the prolonged time required to initialize, and subsequently complete, the backup of data across failover databases.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart describing a method for processing a data backup request in accordance with one or more embodiments of the invention.

FIG. 3 shows a computing system in accordance with one or more embodiments of the invention.

FIG. 4 shows an example system in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

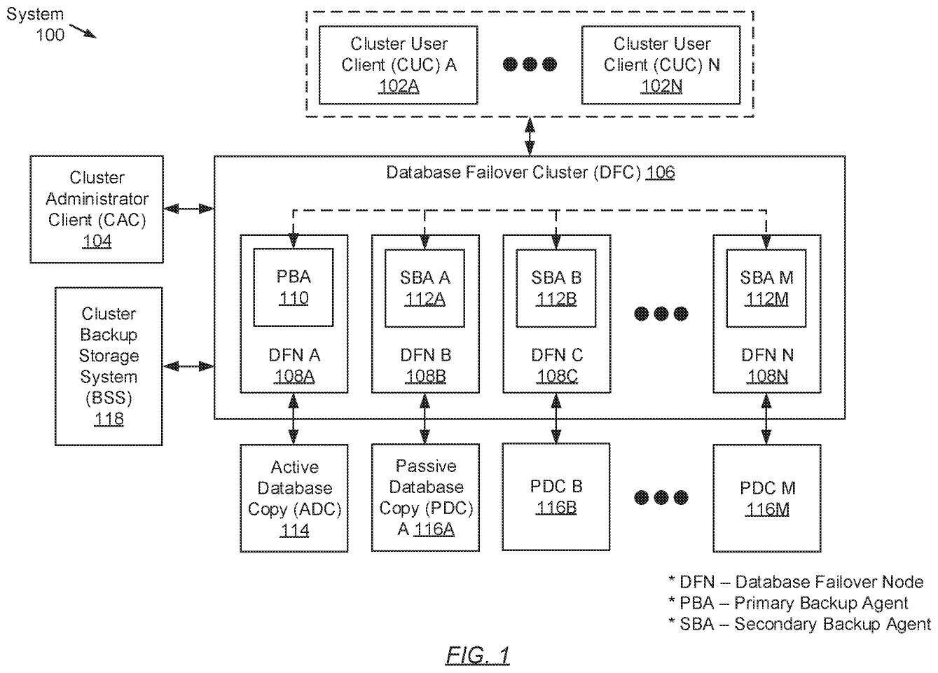

In the following description of FIGS. 1-4, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every, other figure having one or more like-named components. Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a decoupled backup solution for distributed databases across a failover cluster. Specifically, one or more embodiments of the invention improves upon a limitation of existing backup mechanisms involving distributed databases across a failover cluster. The limitation entails restraining backup agents, responsible for executing database backup processes across the failover cluster, from immediately initiating these aforementioned processes upon receipt of instructions. Rather, due to this limitation, these backup agents must wait until all backup agents, across the failover cluster, receive their respective instructions before being permitted to initiate the creation of backup copies of their relative distributed database. Subsequently, the limitation imposes an initiation delay on the backup processes, which one or more embodiments of the invention omits, thereby granting any particular backup agent the capability to immediately (i.e., without delay) initiate those backup processes.

FIG. 1 shows a system in accordance with one or more embodiments of the invention. The system (100) may include one or more cluster user clients (CUCs) (102A-102N), a cluster administrator client (CAC) (104), a database failover cluster (DFC) (106), and a cluster backup storage system (BSS) (118). Each of these components is described below.

In one embodiment of the invention, the above-mentioned components may be directly or indirectly connected to one another through a network (not shown) (e.g., a local area network (LAN), a wide area network (WAN) such as the Internet, a mobile network, or any other network). The network may be implemented using any combination of wired and/or wireless connections. In embodiments in which the above-mentioned components are indirectly connected, there may be other networking components or systems (e.g., switches, routers, gateways, etc.) that facilitate communications, information exchange, and/or resource sharing. Further, the above-mentioned components may communicate with one another using any combination of wired and/or wireless communication protocols.

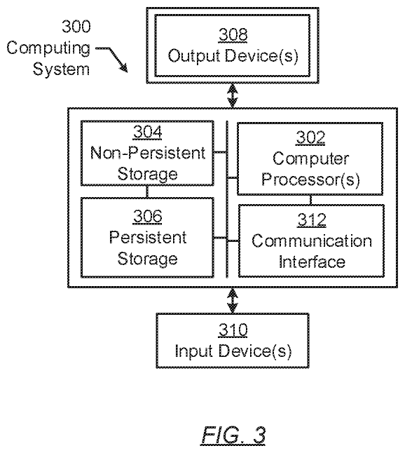

In one embodiment of the invention, a CUC (102A-102N) may be any computing system operated by a user of the DFC (106). A user of the DFC (106) may refer to an individual, a group of individuals, or an entity for which the database(s) of the DFC (106) is/are intended; or whom accesses the database(s). Further, a CUC (102A-102N) may include functionality to: submit application programming interface (API) requests to the DFC (106), where the API requests may be directed to accessing (e.g., reading data from and/or writing data to) the database(s) of the DFC (106); and receive API responses, from the DFC (106), entailing, for example, queried information. One of ordinary skill will appreciate that a CUC (102A-102N) may perform other functionalities without departing from the scope of the invention. Examples of a CUC (102A-102N) include, but are not limited to, a desktop computer, a laptop computer, a tablet computer, a server, a mainframe, a smartphone, or any other computing system similar to the exemplary computing system shown in FIG. 3.

In one embodiment of the invention, the CAC (104) may be any computing system operated by an administrator of the DFC (106). An administrator of the DFC (106) may refer to an individual, a group of individuals, or an entity whom may be responsible for overseeing operations and maintenance pertinent to hardware, software, and/or firmware elements of the DFC (106). Further, the CAC (104) may include functionality to: submit data backup requests to a primary backup agent (PBA) (110) (described below), where the data backup requests may pertain to the performance of decoupled distributed backups of the active and one or more passive databases across the DFC (106); and receive, from the PBA (110), aggregated reports based on outcomes obtained through the processing of the data backup requests. One of ordinary skill will appreciate that the CAC (104) may perform other functionalities without departing from the scope of the invention. Examples of the CAC (104) include, but are not limited to, a desktop computer, a laptop computer, a tablet computer, a server, a mainframe, a smartphone, or any other computing system similar to the exemplary computing system shown in FIG. 3.

In one embodiment of the invention, the DFC (106) may refer to a group of finked nodes—i.e., database failover nodes (DFNs) (108A-108N) (described below)—that work together to maintain high availability (or minimize downtime) of one or more applications and/or services. The DFC (106) may achieve the maintenance of high availability by distributing any workload (i.e., applications and/or services) across or among the various DFNs (108A-108N) such that, in the event that any one or more DFNs (108A-108N) go offline, the workload may be subsumed by, and therefore may remain available on, other DFNs (108A-108N) of the DFC (106). Further, reasons for which a DFN (108A-108N) may go offline include, but are not limited to, scheduled maintenance, unexpected power outages, and failure events induced through, for example, hardware failure, data corruption, and other anomalies caused by cyber security attacks and/or threats. Moreover, the various DFNs (108A-108N) in the DFC (106) may reside in different physical (or geographical) locations in order to mitigate the effects of unexpected power outages and failure (or failover) events. By way of an example, the DFC (106) may represent a Database Availability Group (DAG) or a Windows Server Failover Cluster (WSFC), which may each encompass multiple Structured Query. Language (SQL) servers.

In one embodiment of the invention, a DFN (108A-108N) may be a physical appliance—e.g., a server or any computing system similar to the exemplary computing system shown in FIG. 3. Further, each DFN (108A-108N) may include functionality to maintain an awareness of the status of every other DFN (108A-108N) in the DFC (106). By way of an example, this awareness may be implemented through the periodic issuance of heartbeat protocol messages between DFNs (108A-108N), which serve to indicate whether any particular DFN (108A-108N) may be operating normally or, for some reason, may be offline. In the occurrence of an offline event on one or more DFNs (108A-108N), as mentioned above, the remaining (operably normal) DFNs (108A-108N) may assume the responsibilities (e.g., provides the applications and/or services) of the offline DFNs (108A-108N) without, or at least while minimizing, downtime experienced by the end users (i.e., operators of the CUCs (102A-102N)) of the DFC (106).

In one embodiment of the invention, the various DFNs (108A-108N) in the DFC (106) may operate under an active-standby (or active-passive) failover configuration. That is, under the aforementioned failover configuration, one of the DFNs (108A) may play the role of the active (or primary) node in the DFC (106), whereas the remaining one or more DFNs (108B-108N) may play the role of the standby (or secondary) node(s) in the DFC (106). With respect to roles, the active node may refer to a node to which client traffic (i.e., network traffic originating from one or more CUCs (102A-102N)) may currently be directed. A standby node, on the other hand, may refer to a node that may currently not be interacting with one or more CUCs (102A-102N).

In one embodiment of the invention, each DFN (108A-108N) may host a backup agent (110, 112A-112M) thereon. Specifically, the active (or primary) DFN (108A) of the DFC (106) may host a primary backup agent (PBA) (110), whereas the one or more standby (or secondary) DFNs (108B-108N) of the DFC (106) may each host a secondary backup agent (SBA) (112A-112M). In general, a backup agent (110, 112A-112M) may be a computer program or process (i.e., an instance of a computer program) tasked with performing data backup operations entailing the replication, and subsequent remote storage, of data residing on the DFN (108A-108N) on which the backup agent (110, 112A-112M) may be executing. In one embodiment of the invention, a PBA (110) may refer to a backup agent that may be executing on an active DFN (108A), whereas a SBA (112A-112M) may refer to a backup agent that may be executing on a standby DFN (108B-108N).

In one embodiment of the invention, the PBA (110) may include functionality to: receive data backup requests from the CAC (104), where the data backup requests may pertain to the initialization of data backup operations across the DFC (106); initiate primary data backup processes on the active (or primary) node (i.e., on which the PBA (110) may be executing) in response to the data backup requests from the CAC (104); also in response to the data backup requests from the CAC (104), issue secondary data backup requests to the one or more SBAs (112A-112M) executing on the one or more standby (or secondary) nodes in the DFC (106), where the secondary data backup requests pertain to the initialization of data backup operations at each standby node, respectively; obtain an outcome based on the performing of the data backup operations on the active node, where the outcome may indicate that performance of the data backup operations was either a success or a failure; receive data backup reports from the one or more SBAs (112A-112M) pertaining to outcomes obtained based on the performing of data backup operations on the one or more standby nodes, where each data backup report may indicate that the performance of the data backup operations, on the respective standby node, was either a success or a failure; aggregate the various outcomes, obtained at the active node or through data backup reports received from one or more standby nodes, to generate aggregated data backup reports; and issue, transmit, or provide the aggregated data backup reports to the CAC (104) in response to data backup requests received therefrom.

In one embodiment of the invention, a SBA (112A-112M) may include functionality to: receive secondary data backup requests from the PBA (11.0), where the secondary data backup requests pertain to the initialization of data backup operations on the standby (or secondary) node on which the SBA (112A-112M) may be executing; immediately afterwards (i.e., not waiting on other SBAs (112A-112M) to receive their respective secondary data backup requests), initiate secondary data backup processes on their respective standby node; obtain an outcome based on the performing of the secondary data backup processes on their respective standby node, where the outcome may indicate that performance of the secondary data backup processes was either a success or a failure; generate data backup reports based on the obtained outcome(s); and issue, transmit, or provide the data backup reports to the PBA (110) in response to the secondary data backup requests received therefrom.

In one embodiment of the invention, data backup operations (or processes), performed by any backup agent (110, 112A-112M), may entail creating full database backups, differential database backups, and/or transaction log backups of the database copy (114, 116A-116M) (described below) residing on or operatively connected to the DFN (108A-108N) on which the backup agent (110, 112A-112M) may be executing. A full database backup may refer to the generation of a backup copy containing all data files and the transaction log residing on the database copy (114, 116A-116M). The transaction log may refer to a data object or structure that records all transactions, and database changes made by each transaction, pertinent to the database copy (114, 116A-116M). A differential database backup may refer to the generation of a backup copy containing all changes made to the database copy (114, 116A-116M) since the last full database backup, and the transaction log, residing on the database copy (114, 116A-116M). Meanwhile, a transaction log backup may refer to the generation of a backup copy containing all transaction log records that have been made between the last transaction log backup, or the first full database backup, and the last transaction log record that may be created upon completion of the data backup process. In one embodiment of the invention, upon the successful creation of a full database backup, a differential database backup, and/or a transaction log backup, each backup agent (110, 112A-112M) may include further functionality to submit the created backup copy to the cluster BSS (118) for remote consolidation.

In one embodiment of the invention, a database copy (114, 116A-116M) may be a storage system or media for consolidating various forms of information pertinent to the DFN (108A-108N) on which the database copy (114, 116A-116M) may be residing or to which the database copy (114, 116A-116M) may be operatively connected. Information consolidated in the database copy (114, 116A-116M) may be partitioned into either a data files segment (not shown) or a log files segment (not shown). Information residing in the data files segment may include, for example, data and objects such as tables, indexes, stored procedures, and views. Further, any information written to the database copy (114, 116A-116M), by one or more end users, may be retained in the data files segment. On the other hand, information residing in the log files segment may include, for example, the transaction log (described above) and any other metadata that may facilitate the recovery of any and all transactions in the database copy (114, 116A-116M).

In one embodiment of the invention, a database copy (114, 116A-116M) may span logically across one or more physical storage units and/or devices, which may or may not be of the same type or co-located at a same physical site. Further, information consolidated in a database copy (114, 116A-116M) may be arranged using any storage mechanism (e.g., a filesystem, a collection of tables, a collection of records, etc.). In one embodiment of the invention, a database copy (114, 116A-116M) may be implemented using persistent storage (i.e., non-volatile) storage media. Examples of persistent storage media include, but are not limited to: optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage media defined as non-volatile Storage Class Memory (SCM).

In one embodiment of the invention, within the DFC (106), there may be one active database copy (ADC) (114) and one or more passive database copies (PDCs) (116A-116M). The ADC (114) may refer to the database copy that resides on, or is operatively connected to, the active (or primary) DFN (108A) in the DFC (106). Said another way, the ADC (114) may refer to the database copy that may be currently hosting the information read therefrom and written thereto by the one or more CUCs (102A-102N) via the active DFN (108A). Accordingly, the ADC (114) may be operating in read-write (RW) mode, which grants read and write access to the ADC (114). On the other hand, a PDC (116A-116M) may refer to a database copy that resides on, or is operatively connected to, a standby (or secondary) DFN (108B-108N) in the DFC (106). Said another way, a PDC (116A-116M) may refer to a database copy with which the one or more CUCs (102A-102N) may not be currently engaging. Accordingly, a PDC (116A-116M) may be operating in read-only (RO) mode, which grants only read access to a PDC (116A-116M). Further, in one embodiment of the invention, a PDC (116A-116M) may include functionality to: receive transaction log copies of the transaction log residing on the ADC (114) from the PBA (110) via a respective SBA (114A-114M); and apply transactions, recorded in the received transaction log copies, to the transaction log residing on the PDC (116A-116M) in order to maintain the PDC (116A-116M) up-to-date with the ADC (114).

In one embodiment of the invention, the cluster BSS (118) may be a data backup, archiving, and/or disaster recovery storage system or media that consolidates various forms of information. Specifically, the cluster BSS (118) may be a consolidation point for backup copies (described above) created, and subsequently submitted, by the PBA (110) and the one or more SBAs (112A-112M) while performing data backup operations on their respective DFNs (108A-108N) in the DFC (106). In one embodiment of the invention, the cluster BSS (118) may be implemented using one or more servers (not shown). Each server may be a physical server (i.e., in a datacenter) or a virtual server (i.e., residing in a cloud computing environment). In another embodiment of the invention, the cluster BSS (118) may be implemented using one or more computing systems similar to the exemplary computing system shown in FIG. 3.

In one embodiment of the invention, the cluster BSS (118) may further be implemented using one or more physical storage units and/or devices, which may or may not be of the same type or co-located in a same physical server or computing system. Further, the information consolidated in the cluster BSS (118) may be arranged using any storage mechanism (e.g., a filesystem, a collection of tables, a collection of records, etc.). In one embodiment of the invention, the cluster BSS (118) may be implemented using persistent (i.e., non-volatile) storage media. Examples of persistent storage media include, but are not limited to: optical storage, magnetic storage, NAND Flash Memory, NOR Hash Memory, Magnetic Random Access Memory (M-RAM), Spin Torque Magnetic RAM (ST-MRAM), Phase Change Memory (PCM), or any other storage media defined as non-volatile Storage Class Memory (SCM).

While FIG. 1 shows a configuration of components, other system configurations may be used without departing from the scope of the invention. For example, the DFC (106) (i.e., the various DFNs (108A-108N)) may host, or may be operatively connected to, more than one set of database copies. A set of database copies may entail one ADC (114) and one or more corresponding PDCs (116A-116M) that maintain read-only copies of the one ADC (114). Further, the active (or primary) node, and respective standby (or secondary) nodes, for each set of database copies may be different. That is, for example, for a first set of database copies, the respective ADC (114) may be hosted on or operatively connected to a first DFN (108A) in the INC (106). Meanwhile, for a second set of database copies, the respective ADC (114) may be hosted on or operatively connected to a second DFN (108B) in the DFC (106). Moreover, for a third set of database copies, the respective ADC (114) may be hosted on or operatively connected to a third DFN (108C) in the DFC (106).

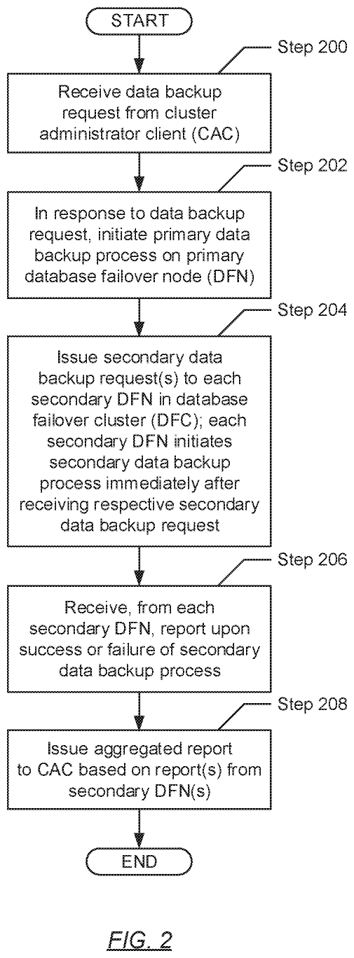

FIG. 2 shows a flowchart describing a method for processing a data backup request in accordance with one or more embodiments of the invention. While the various steps in the flowcharts are presented and described sequentially, one of ordinary skill will appreciate that some or all steps may be executed in different orders, may be combined or omitted, and some or all steps may be executed in parallel.

Turning to FIG. 2, in Step 200, a data backup request is received from a cluster administrator client (CAC). In one embodiment of the invention, the data backup request may pertain to the initialization of data backup operations (or processes) across the various database failover nodes (DFNs) (see e.g., FIG. 1) in a database failover cluster (DFC). Further, the data backup request may specify the creation of a full database backup, a differential database backup, or a transaction log backup of the various database copies hosted on, or operatively connected to, the various DFNs, respectively.

In Step 202, in response to the data backup request (received in Step 200), a primary data backup process is initiated on an active (or primary) DFN (see e.g., FIG. 1). In one embodiment of the invention, the primary data backup process may entail replicating, and thereby creating a backup copy of, an active database copy (ADC) hosted on, or operatively connected to, the active/primary INN. Further, if the replication process is successful, the primary data backup process may further entail submission of the created backup copy to a cluster backup storage system (BSS) (see e.g., FIG. 1) for data backup, archiving, and/or disaster recovery purposes. Alternatively, the replication process may end in failure due to the presence or occurrence of one or more database-related errors.

In Step 204, one or more secondary data backup requests is/are issued to one or more secondary backup agents (SBAs), respectively. In one embodiment of the invention, each SBA may be a computer program or process (i.e., an instance of a computer program) executing on the underlying hardware of one of the one or more standby (or secondary) DFNs (see e.g., FIG. 1) in the DFC. Further, each secondary data backup request may pertain to the initialization of a data backup operation (or process) on a respective standby/secondary DFN. Similar to the primary data backup process (initiated in Step 202), each secondary data backup process may entail, as performed by each respective SBA, replicating, and thereby creating a backup copy of, a respective passive database copy (PDC) hosted on, or operatively connected to, the standby/secondary DFN on which the respective SBA may be executing. Further, if the replication process is successful for a respective PDC, the secondary data backup process may further entail submission of the created backup copy to the cluster BSS for data backup, archiving, and/or disaster recovery purposes. Alternatively, the replication process for a respective PDC may end in failure due to the presence or occurrence of one or more database-related errors.

In one embodiment of the invention, upon receipt of a secondary data backup request, each SBA may immediately proceed with the initiation of the data backup operation (or process) on their respective standby/secondary DFNs. This immediate initiation of data backup operations/processes represents a fundamental improvement (or advantage) that embodiments of the invention provide over existing or traditional data backup mechanisms for database failover clusters (DFCs). That is, through existing/traditional data backup mechanisms, each SBA is required to wait until all SBAs in the DFC have received a respective secondary data backup request before each SBA is permitted to commence the data backup operation/process on their respective standby/secondary DFN. For DFCs hosting or operatively connected to substantially large database copies (e.g., where the total data size collectively consolidated on the database copies may reach up to 25,600 terabytes (TB) or 25.6 petabytes (PB) of data), the elapsed backup time, as well as the allocation and/or utilization of resources on an active/primary DFN, associated with performing backup operations (or processes) may proportionally be large in scale. Accordingly, by enabling SBAs to immediately initiate data backup operations processes upon receipt of a secondary data backup request (rather than having them wait until all. SBAs have received their respective secondary data backup request), one or more embodiments of the invention reduce the overall time expended to complete the various data backup operations/processes across the DIV.

In Step 206, a data backup report is received from each SBA (to which a secondary data backup request had been issued in Step 204). In one embodiment of the invention, each data backup report may entail a message that indicates an outcome of the initiation of a secondary data backup process on a respective standby/secondary DFN. Subsequently, in one embodiment of the invention, a data backup report may relay a successful outcome representative of a successful secondary data backup process—i.e., the successful creation of a backup copy and the subsequent submission of the backup copy to the cluster BSS. In another embodiment of the invention, a data backup report may alternatively relay an unsuccessful outcome representative of an unsuccessful secondary data backup process—i.e., the unsuccessful creation of a backup copy due to one or more database-related errors. In one embodiment of the invention, similar outcomes may be obtained from the performance of the primary data backup process on the active/primary DFN (initiated in Step 202).

In Step 208, an aggregated data backup report is issued back to the CAC (wherefrom the data backup request had been received in Step 200). In one embodiment of the invention, the aggregated data backup report may entail a message that indicates the outcomes (described above) pertaining to the various data backup processes across the DFC. Therefore, the aggregated data backup report may be generated based on the outcome obtained through the primary data backup process performed on the active/primary DFN in the DFC, as well as based on the data backup report received from each SBA, which may specify the outcome obtained through a secondary data backup process performed on a respective standby/secondary DFN in the DFC.

FIG. 3 shows a computing system in accordance with one or more embodiments of the invention. The computing system (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing system (300) may also include one or more input devices (310), such as a touchscreen, keyboard, mouse, microphone, touchpad, electronic pen, or any other type of input device. Further, the communication interface (312) may include an integrated circuit for connecting the computing system (300) to a network (not shown) (e.g., a local area network (LAN), a wide area network (WAN) such as the Internet, mobile network, or any other type of network) and/or to another device, such as another computing device.

In one embodiment of the invention, the computing system (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

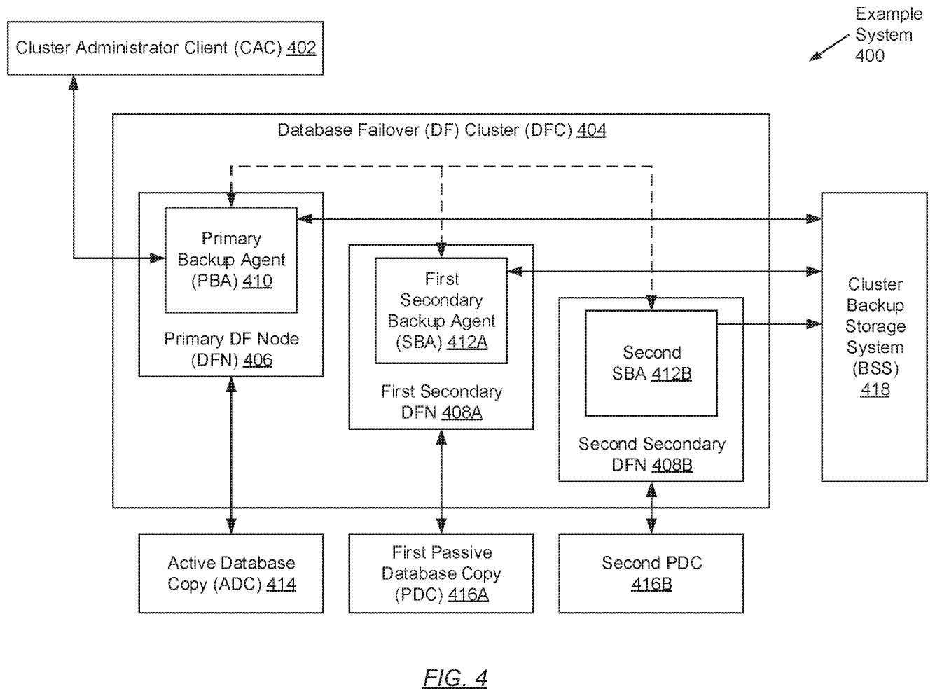

FIG. 4 shows an example system in accordance with one or more embodiments of the invention. The following example, presented in conjunction with components shown in FIG. 4, is for explanatory purposes only and not intended to limit the scope of the invention.

Turning to FIG. 4, the example system (400) includes a cluster administrator client (CAC) (402) operatively connected to a database failover cluster (DFC) (404), where the DFC (404), in turn, is operatively connected to a cluster backup storage system (BSS) (418). Further, the DFC (404) includes three database failover nodes (DFNs)—a primary DFN (406), a first secondary DFN (408A), and a second secondary DFN (408B). A primary backup agent (PBA) (410) is executing on the primary DFN (406), whereas a first secondary backup agent (SBA) (412A) and a second SBA (412B) are executing on the first and second secondary DFNs (408A, 408B), respectively. Moreover, the primary DFN (406) is operatively connected to an active database copy (ADC) (414), the first secondary DFN (408A) is operatively connected to a first passive database copy (PDC) (416A), and the second secondary DFN (408B) is operatively connected to a second PDC (416B).

Turning to the example, consider a scenario whereby the CAC (402) issues a data backup request to the DFC (404). Following embodiments of the invention, the PBA (410) receives the data backup request. In response to receiving the data backup request, the PBA (410) initiates a primary data backup process at the primary DFN (406) directed to creating a backup copy of the ADC (414). After initiating the primary data backup process, the PBA (410) issues secondary data backup requests to the first and second SBAs (412A, 412B). Thereafter, upon receipt of a secondary data backup request, the first SBA (412A) immediately initiates a secondary data backup process at the first secondary DFN (408A), where the secondary data backup process is directed to creating a backup copy of the first PDC (416A). Similarly, upon receipt of another secondary data backup request, the second SBA (412B) immediately initiates another secondary data backup process at the second secondary DFN (408B), where the other secondary data backup process is directed to creating a backup copy of the second PDC (416B).

In contrast, had the first and second SBAs (412A, 412B) been Operating using the existing or traditional backup mechanism for DFCs, upon receipt of a secondary data backup request, the first SBA (412A) refrains from initiating a secondary data backup process at the first secondary DFN (408A) until after all other SBAs (i.e., the second SBA (412B)) have received their respective secondary data backup request. Substantively, an initiation delay is built into the existing or traditional mechanism, which prevents any and all SBAs across the DFC to initiate a secondary data backup process until every single SBA receives a secondary data backup request. In the example system (400) portrayed, with the DFC (404) consisting of only two SBAs (412A, 412B), the initiation delay may be negligible. However, in real-world environments, where DFCs may include hundreds, if not, thousands of SBAs, the initiation delay may be substantial, thereby resulting in longer backup times, over-utilization of production (i.e., primary DFN (406)) resources, and other undesirable effects, which burden the performance of the DFC (404) and the overall user experience.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for optimizing distributed database backups, comprising:
receiving, at a secondary node, a secondary data backup request from a primary node; and
while at least one other secondary node has yet to receive another secondary data backup request from the primary node:
initiating, in response to the secondary data backup request, a secondary data backup process on the secondary node.

2. The method of claim 1, wherein the secondary data backup process, comprises:
creating a backup copy of a passive database copy (PDC) that is one selected from a group consisting of hosted on and operatively connected to, the secondary node; and
submitting the backup copy for remote consolidation on a cluster backup storage system (BSS).

3. The method of claim 2, wherein the backup copy is one selected from a group consisting of a full database backup, a differential database backup, and a transaction log backup.

4. The method of claim 2, wherein the PDC is a standby database copy of an active database copy (ADC).

5. The method of claim 4, wherein the ADC is one selected from a group consisting of hosted on and operatively connected to, the primary node.

6. The method of claim 1, wherein the secondary node and the at least one other secondary node are standby nodes for the primary node.

7. The method of claim 1, further comprising:
generating a data backup report based on an outcome of the secondary data backup process; and
issuing the data backup report to the primary node.

8. A system, comprising:
a plurality of database failover nodes (DFNs);
a primary backup agent (PBA) executing on a first DFN of the plurality of DFNs; and
a secondary backup agent (SBA) executing on a second DFN of the plurality of DFNs,
wherein the SBA is operatively connected to the PBA, and programmed to:
receive a secondary data backup request from the PBA; and
while at least one other SBA has yet to receive another secondary data backup request from the PBA:
initiate, in response to the secondary data backup request, a secondary data backup process on the second DFN.

9. The system of claim 8, further comprising:
a third DFN of the plurality of DFNs,
wherein the at least one other SBA executes on the third DFN, and is operatively connected to the PBA.

10. The system of claim 8, further comprising:
a passive database copy (PDC) that is one selected from a group consisting of hosted on and operatively connected to, the second DFN,
wherein the secondary data backup process comprises creating a backup copy of the PDC.

11. The system of claim 8, wherein the PBA is programmed to:
prior to the SBA receiving the secondary data backup request:
receive a first data backup request; and
in response to the first data backup request:
initiate a primary data backup process on the first DFN; and
issue, after initiating the primary data backup process, at least one secondary data backup request to at least one SBA,
wherein the at least one secondary data backup request comprises the secondary data backup request and the another secondary data backup request,
wherein the at least one SBA comprises the SBA and the at least one other SBA.

12. The system of claim 11, further comprising:
a cluster administrator client (CAC) operatively connected to the PBA,
wherein the first data backup request is received from the CAC.

13. The system of claim 12, wherein the PBA is further programmed to:
obtain a first outcome based on performing the primary data backup process;
receive, from the SBA, a data backup report specifying a second outcome based on a performance of the secondary data backup process; and
receive, from the at least one other SBA, at least one other data backup report specifying at least one other outcome based on at least one other performance of at least one other secondary data backup process;
generate an aggregated data backup report based on the first outcome, the second outcome, and the at least one other outcome; and
issue the aggregated data backup report to the CAC.

14. The system of claim 11, further comprising:
an active database copy (ADC) that is one selected from a group consisting of hosted on and operatively connected to, the first DFN,
wherein the primary data backup process comprises creating a backup copy of the ADC.

15. The system of claim 8, further comprising:
a database failover cluster (DFC) comprising the plurality of DFNs.

16. The system of claim 8, further comprising:
a cluster backup storage system (BSS) operatively connected to the plurality of DFNs,
wherein the secondary data backup process comprises creating a backup copy and consolidating the backup copy in the cluster BSS.

17. A non-transitory computer readable medium (CRM) comprising computer readable program code, which when executed by a computer processor, enables the computer processor to:
receive, at a secondary node, a secondary data backup request from a primary node; and
while at least one other secondary node has yet to receive another secondary data backup request from the primary node:
initiate, in response to the secondary data backup request, a secondary data backup process on the secondary node.

18. The non-transitory CRM of claim 17, wherein the secondary data backup process, comprises enabling the computer processor to:
create a backup copy of a passive database copy (PDC) that is one selected from a group consisting of hosted on and operatively connected to, the secondary node; and
submit the backup copy for remote consolidation on a cluster backup storage system (BSS).

19. The non-transitory CRM of claim 17, wherein the secondary node and the at least one other secondary node are standby nodes for the primary node.

20. The non-transitory CRM of claim 17, further comprising computer readable program code, which when executed by the computer processor, enables the computer processor to:
generate a data backup report based on an outcome of the secondary data backup process; and
issue the data backup report to the primary node.
